(19) United States
(12) Patent Application Publication
(10) Pub. No.: US 2002/0029590 A1
(43) Pub. Date: Mar. 14, 2002

(54) Vacuum refining unit for a glass melt

(76) Inventors: Thorsten Wilke, Mainz (DE); Rainer Eichholz, Mainz (DE); Manfred Daubner, Wiesbaden (DE)

Correspondence Address: Pauley Petersen Kinne & Fejer, 2800 W. Higgins Road, Suite 365, Hoffman Estates, IL, 60195, US

(21) Appl. No.: 09/950,105

(22) Filed: Sep. 10, 2001

(30) Foreign Application Priority Data
Sep. 9, 2000 (DE) 100 44 598.5-45

(51) Int. Cl. C03B 5/225

(52) U.S. Cl. 65/157; 65/162; 65/346

(57) ABSTRACT

A vacuum refining unit wherein, with a vacuum pump connected via a suction line, a vacuum is created above a glass melt to be refined. A valve for supplying secondary air from the atmosphere, for maintaining the pressure conditions in the vacuum unit constant, branches off the suction line. Refining is improved because the vacuum circuit has a controllable leak which provides an inflow of secondary air as a function of different measuring values and thus provides constant refining conditions.

### BACKGROUND OF THE INVENTION

1. Field of the Invention

This invention relates to a vacuum refining unit wherein, by a vacuum pump connected via a suction line, a vacuum is created above a glass melt to be refined, and wherein a valve for supplying secondary air from the atmosphere for maintaining the pressure conditions in the vacuum unit constant branches off from the suction line.

2. Description of Related Art

Refining a glass melt, for example the removal of gas bubbles from the glass melt, is used to eliminate bubbles. In connection with small crucible melts, the rising of gas bubbles from the glass melt is accelerated by applying a vacuum above the glass melt.

A vacuum refining unit of the type mentioned above is known from European Patent Reference EP 0 989 099 A1, wherein a vacuum pump and a valve branching off the suction line are connected with each other via a control circuit. In this case a reference value for the vacuum is preset via the valve, and the control circuit regulates the operating vacuum of the vacuum pump so that a vacuum, which corresponds to the preset or reference value, is maintained in the vacuum unit.

This type of regulation of the vacuum in the vacuum refining unit has one disadvantage that occurring additional leaks in the vacuum unit and the associated line system cannot be removed by regulation, so that the regulation is more or less accurate and does not result in an optimal refining of the glass melt. Also, the vacuum pump has fairly long reaction times, which results in a control process with long response times.

### SUMMARY OF THE INVENTION

It is one object of this invention to create a vacuum refining unit, so that additional leaks occurring in the vacuum refining unit and its line system are removed by regulation, and the regulating process has small regulating time constants.

This object is achieved according to this invention with an absolute pressure in the vacuum unit that can be detected by a pressure sensor. The vacuum pump is operated with an operating vacuum exceeding the maximum absolute pressure. As a function of the detected absolute pressure in the vacuum unit and a preset or reference value of the absolute pressure, the valve, designed as a control valve and branching off the suction line, regulates the absolute pressure in the vacuum unit to the preset or reference value by an appropriate supply of secondary air. The pressure differential between the absolute pressure in the vacuum unit and the atmospheric pressure can be detected by a pressure sensor. The vacuum pump is operated at an operating vacuum exceeding the maximum pressure differential and, as a function of the detected pressure differential and a preset or reference value for the pressure differential the valve, which is designed as a control valve and branches off the suction line, regulates the pressure differential to the preset or reference value by an appropriate supply of secondary air. The glass level in the vacuum unit can be detected by a glass level sensor. The vacuum pump is operated at an operational vacuum associated with the maximum glass level. As a function of the detected glass level and a preset or reference value of the glass level, the valve, which is designed as a regulating valve and branches off the suction line, regulates the glass level to the preset or reference value by an appropriate addition of secondary air.

The vacuum pump is operated so that the vacuum is sufficient for maximum operations. The vacuum pump is no longer regulated and always operates under the same operating conditions. The regulation is performed by the control valve, which has faster reactions. When regulating the glass level in the vacuum unit, the varying pressure as a result of hydrostatic pressure leads to a changing glass level, so that constant refining conditions are also achieved.

The derivation of a control signal for the control valve is simplified in accordance with one embodiment because the detected absolute pressure, the pressure differential or the glass level can be supplied to a measuring transducer, whose electrical output signal is passed on to an electrical regulator of the control valve as the regulating signal.

In accordance with a further embodiment of this invention, the vacuum refining unit can also be employed in connection with chemical or physical refining in order to further improve the refining effect.

### BRIEF DESCRIPTION OF THE DRAWINGS

This invention is explained in detail in view of exemplary embodiments represented in the drawings, wherein:

FIG. 1 is a basic diagram of a vacuum unit with regulation of an absolute pressure in a vacuum unit;

FIG. 2 is a basic diagram of a vacuum unit with regulation of a pressure differential between an absolute pressure in a vacuum unit and a pressure of an outside atmosphere; and

FIG. 3 is a basic diagram of a vacuum unit with regulation of a glass level in a vacuum unit.

### DESCRIPTION OF PREFERRED EMBODIMENTS

All exemplary embodiments have in common that a vacuum pump 20 generates a vacuum above a glass melt in a vacuum unit 10, and the vacuum pump 20 is in a fixed operating state, which is associated with a maximum reference value of a regulating device.

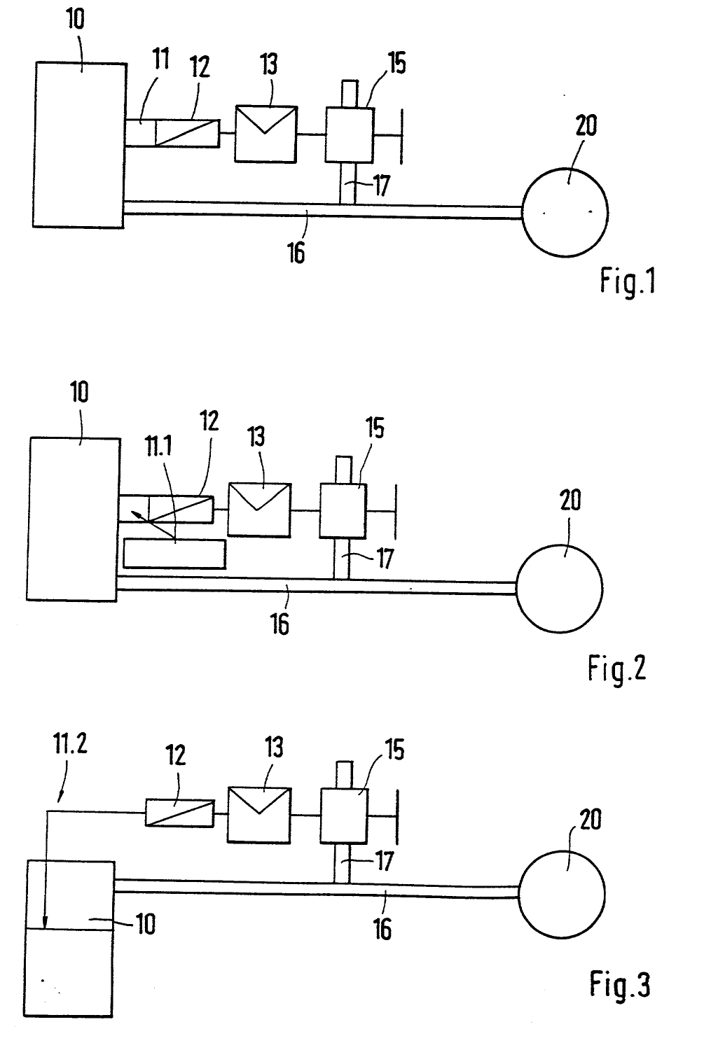

During regulation of the absolute pressure in accordance with FIG. 1, a pressure sensor 11 monitors the absolute pressure in the vacuum unit 10. The output signal of the pressure sensor 11 is converted into an electrical measured value signal by means of a measuring transducer 12 and is supplied to an electrical regulator 13 of a control device. The regulator 13 controls a control valve 15, for example, through which more or less secondary air can enter the vacuum circuit. The regulator 13 and the control valve 15 provide a controllable leak in the vacuum circuit. It is possible to fixedly preset a reference value of the desired absolute pressure in the vacuum unit 10 at the regulator 13. The leak is more and more reduced with an increasing absolute pressure, for example a reference value. The control valve 15 can block the inflow of secondary air at the maximum reference value, so that the vacuum pump 20 alone determines the absolute pressure in the vacuum unit 10.

With the pressure differential regulation in accordance with FIG. 2, and as a variation of the embodiment in accordance with FIG. 1, only one pressure sensor 11.1 is employed, which detects a pressure difference between the absolute pressure in the vacuum unit 10 and the pressure of the external atmosphere and which passes an electrical measured value signal, which corresponds to the detected pressure difference, via the measuring transducer 12 to the regulator 13, which presets a reference value for the pressure difference. The control valve 15 regulates the inflow of secondary air into the vacuum circuit accordingly, so that the preset reference value is reached.

Finally, in the embodiment in accordance with FIG. 3, a glass level sensor 11.2 is employed, which detects the glass level in the vacuum unit 10 and provides the detected measured value signal to the regulator 13 via the measuring transducer 12. A reference value for the glass level is preset at the regulator 13, and the control valve 15 controls the inflow into the vacuum circuit so that a glass level, which corresponds to the preset reference value, is regulated in the vacuum unit 10. The vacuum pump 20 operates at the operating conditions matched to maximum vacuum, and the controllable leak, provided by the control valve 15 with the regulator 13, provides regulation to the set reference value of the glass level.

The vacuum refining unit in accordance with FIGS. 1, 2 or 3 can be used as the sole device for refining a glass melt. However, it can also be employed in connection with chemical or physical refining.

What is claimed is:

1. In a vacuum refining unit wherein a vacuum pump connected via a suction line creates a vacuum above a glass melt to be refined, and wherein a valve for supplying secondary air from an atmosphere for maintaining constant pressure conditions in the vacuum unit branches off the suction line, the improvement comprising:
detecting an absolute pressure in the vacuum unit (10) with a pressure sensor (11);
operating the vacuum pump (20) with an operating vacuum exceeding a maximum absolute pressure; and
regulating as a function of a detected absolute pressure in the vacuum unit (10) and a preset value of an absolute pressure the valve, designed as a control valve (15) and which branches off the suction line (16), the absolute pressure in the vacuum unit (10) to the preset value by an appropriate supply of secondary air.

2. In a vacuum refining unit wherein, a vacuum pump connected via a suction line creates a vacuum above a glass melt to be refined, and wherein a valve for supplying secondary air from an atmosphere for maintaining constant pressure conditions in the vacuum unit branches off the suction line, the improvement comprising:
detecting a pressure differential between an absolute pressure in the vacuum refining unit (10) and an atmospheric pressure with a pressure sensor (11.1);
operating the vacuum pump (20) at an operating vacuum exceeding a maximum pressure differential; and
regulating as a function of a detected pressure differential and a preset value for a pressure differential the valve, designed as a control valve (15) and which branches off the suction line (16), the pressure differential to the preset value by an appropriate supply of secondary air.

3. In a vacuum refining unit wherein a vacuum pump connected via a suction line creates a vacuum above a glass melt to be refined, and wherein a valve for supplying secondary air from an atmosphere for maintaining constant pressure conditions in the vacuum unit branches off the suction line, the improvement comprising:
detecting a glass level in the vacuum refining unit (10) with a glass level sensor (11.2);
operating the vacuum pump (20) at an operational vacuum associated with a maximum glass level; and
regulating as a function of a detected glass level and a preset value of the glass level, the valve, designed as a regulating valve (15) and which branches off the suction line (16), the glass level to the preset value by an appropriate addition of secondary air.

4. In the vacuum refining unit in accordance with claim 3, wherein one of the detected absolute pressure, the pressure differential and the glass level is supplied to a measuring transducer (12) having an electrical output signal supplied to an electrical regulator (13) of the control valve (15) as a regulating signal.

5. In the vacuum refining unit in accordance with claim 4, wherein the vacuum refining unit is employed in a chemical refining process.

6. In the vacuum refining unit in accordance with claim 5, wherein the vacuum refining unit is employed in a physical refining process.

7. In the vacuum refining unit in accordance with claim 1, wherein one of the detected absolute pressure, a pressure differential and a glass level is supplied to a measuring transducer (12) having an electrical output signal supplied to an electrical regulator (13) of the control valve (15) as a regulating signal.

8. In the vacuum refining unit in accordance with claim 7, wherein the vacuum refining unit is employed in a chemical refining process.

9. In the vacuum refining unit in accordance with claim 7, wherein the vacuum refining unit is employed in a physical refining process.

10. In the vacuum refining unit in accordance with claim 2, wherein one of a detected absolute pressure, the pressure differential and the glass level is supplied to a measuring transducer (12) having an electrical output signal supplied to an electrical regulator (13) of the control valve (15) as a regulating signal.

11. In the vacuum refining unit in accordance with claim 10, wherein the vacuum refining unit is employed in a chemical refining process.

12. In the vacuum refining unit in accordance with claim 10, wherein the vacuum refining unit is employed in a physical refining process.
